(19) United States
(12) Patent Application Publication
(10) Pub. No.: US 2016/0258552 A1
(43) Pub. Date: Sep. 8, 2016

(54) DEVICE FOR LOWERING OR RETRIEVAL OF A PIPELINE AT THE SEABED

(71) Applicant: Aker Solutions AS, Lysaker (NO)

(72) Inventor: Johan LARSSON, Arjang (SE)

(73) Assignee: Aker Solutions AS, Lysaker (NO)

(21) Appl. No.: 15/058,340

(22) Filed: Mar. 2, 2016

(30) Foreign Application Priority Data
Mar. 3, 2015 (NO) 20150287

(51) Int. Cl. F16L 1/20; F16L 11/00; F16L 3/015; F16L 1/16; F16L 1/26

(52) U.S. Cl. CPC F16L 1/205; F16L 1/161; F16L 1/207; F16L 1/26; F16L 3/015; F16L 11/00

(57) ABSTRACT

A lifting device for lowering a pipeline end from a water surface to a seabed, alternatively later retrieval of the same from the seabed to the water surface, said pipeline end being provided with an outboard connecting part designed for mating and connection with an inboard connecting part on the seabed. The lifting device includes a hang off clamp adapted for connection with the outboard connecting part, at least one lifting arm pivotably connected to the hang off clamp at a respective first end of said at least one lifting arm and a yoke, said yoke being adapted to be releasable connected to the at least one lifting arm at a respective second end of said lifting arm, said at least one lifting arm having a locking arrangement for securing the at least one lifting arm to the hang off clamp in a non-rotational resting position. A method for lowering of a pipeline end from a water surface and retrieving a pipeline end from a seabed by use of the lifting device is also disclosed.

### FIELD OF THE INVENTION

The present invention relates to a device for lowering, alternatively later retrieval, of a pipeline end provided with a connecting part designed for “horizontal” mating with and connection to a connecting part on the seabed, The present invention relates particularly to a device for lowering, alternatively later retrieval of a second pipeline end where a first pipeline end is already arranged on the seabed.

### TECHNICAL BACKGROUND OF THE INVENTION

When a pipeline, for transportation of for instance oil and gas, is laid out on the seabed and is to be connected to a fixed coupling point, it has been common practice to use a tie-in and connecting tool, which is lowered from the sea surface. The tool is put down over the coupling point and a wire line is brought out from the tool and secured to the pipeline end that is to be tied in before the connecting operation can take place. When the pipeline ends, which have a respective flange, are brought against each other, the connecting operation can take place by means of a clamp connector. The clamp connector has internal beveled surfaces, which cooperate with external beveled surfaces on the pipeline flanges. When the clamp connector is activated, the respective beveled surface effects that the pipeline ends are pulled axially towards each other by substantial force and connecting engagement takes place.

There exist two principles for the connecting devices, either vertical or horizontal. The term horizontal means that the connection device is substantially horizontal related to the seabed. The term vertical means that the connection device is substantially vertical in relation to the seabed.

For a horizontal connecting device the connecting point projects horizontally out from the structure, and the connecting parts are mated in a substantially horizontal direction. In the North Sea this solution almost has market control. Other places, like the Gulf of Mexico for example, the vertical solution is the most common one.

There are in principle three (or actually two) different forms for external connections to a structure as described below:
Direct connection between two structures: Here, a rigid pipe having a mobile connecting part at each end, will normally be used. This will usually be termed a jumper. The jumper is manufactured based on measuring the relative position of the two connecting points.
Connection between the end of a pipeline (rigid pipe) and a structure: It is almost impossible (or at least very difficult) to connect a rigid pipeline directly to a structure preinstalled on the seabed. Thus, an intermediate piece of pipe, frequently termed a “spool”, is provided between the pipeline and the structure. In order to be able to connect the spool to the pipeline, the pipeline will be welded directly to a small structure including a connecting point. A spool is in principle similar to the jumper described above.
Direct connection of a flexible pipeline or umbilical to a structure: In some cases, it is chosen to use so called flexible pipes instead of rigid steel pipes. Such pipes can be compared to a big garden hose. Then it is neither necessary to have a spool or jumper between the end of the pipe and the structure, nor to make precise measurements of the position on the connecting point on the structure.

The application is related to connection of flexible pipelines.

A connecting system of this type usually comprises an inboard connecting part and a landing structure that is lowered to the seabed beforehand, and an outboard connecting part that is connected to a pipeline that is lowered to the seabed for mating with and connection to the inboard connecting part at the seabed. Usually, the inboard connecting part is lowered to the seabed before lowering of the outboard connecting part and the pipeline end, but it is also possible to lower the outboard connecting part with the pipeline end to the seabed before the inboard connecting part is installed at the seabed.

The invention can be used to deploy both a first and a second end of a flexible pipeline. The problems to be addressed can be somewhat different when the first end is to be laid from a surface vessel and down to the seabed compared to deployment of the second end.

When lowering the first pipeline end, the remaining part of the pipeline is at the sea level, the lifting device of the outboard connecting part will therefore carry only the load of the outboard connecting part and a part of the pipeline that is lowered to the seabed.

When the second end of a pipeline is lowered to the seabed, the remaining part of the pipeline is at the seabed and the lifting device for deployment of the second pipeline end has to carry the full load of the pipeline. This load can in total be up to 650 metric tons. The structure must in this case be dimensioned to carry the total load of the pipeline in addition to the outboard connecting part, when the second end pipeline and the outboard connecting part is lowered to the seabed.

In the reverse action, when retrieving the pipeline from the seabed, the lifting device for retrieval of the pipeline end that is lifted first from the seabed towards the sea level, must carry the full load of the pipeline, while the lifting device that is lifting the pipeline that is retrieved last from the seabed will only carry a part of the weight of the pipeline.

Publication NO 331032 describes a tool for lowering and retrieval of a second pipeline end that is provided with a second or outboard connecting part designed for mating with and connection to a first or inboard connecting part on the seabed. The tool comprises a lifting frame, a guiding part that is an extension of the lifting frame. A lifting yoke is connected to the lifting frame through lifting arms. The tool is arranged so that can be brought to the surface for reuse as a whole.

In this publication, it is necessary that the inboard connecting part is lowered and installed at the seabed before the second end is lowered.

The guiding part of the tool is guided by a control structure on the inboard connecting part so that the outboard connecting part is landed on the seabed in a position near the inboard connecting part. In this construction, it is necessary to lower and arrange the inboard connecting part at the seabed before lowering the outboard connecting part.

In the invention according to the application, it is not necessary to have the inboard connecting part at the seabed before lowering the pipeline. On the other hand, it is therefore necessary to have a lifting tool that is not dependent on the inboard connecting part when lowering the pipeline end, and which has a high load capacity.

### OBJECTS OF THE INVENTION

The objective of the present invention is to provide a lifting device for lowering from a surface, alternatively later retrieval to a surface, which lifting device is beneficial over the previous technology with respect to the following issues:

The lifting device has the advantage that it has a high load capacity and can carry the full load of the pipeline or flex line.

The lifting device can be installed before the inboard connecting part is arranged on the seabed.

The lifting device is less complicated in use than previously known lifting devices for this purpose.

The lifting device allows the flexible pipeline to swivel (rotate freely in respect to the lifting device) during landing. This is essential when installing torsion stiff large flexible pipelines.

The lifting device is time efficient and therefore cost effective because it is only the yoke that is retrieved from the seabed when the pipeline is lowered to the seabed. Or, in the opposite case: lowered to the seabed when the pipeline is retrieved from the seabed. The rest of the lifting device is remaining in the seabed together with the pipeline and the outboard connecting part.

The lifting device allows for a safe (low risk of damage) and secure way of releasing and re-docking of the yoke with minimum of help from the ROV

The lifting device has several main components but is in one embodiment of the invention designed so that each main component is in the form of a replaceable module.

The lifting device is primary used to deploy a second end of a flexible pipeline, but can also be used to deploy a first end of the flexible pipeline with some modifications made on to the lifting device. The problems to be addressed can be somewhat different when the first end is to be laid from a surface vessel and down to the seabed compared with deployment of the second end as described above. When the first end is lowered down to the seabed there lifting device only need to carry a portion of the weight of the pipeline since the remaining part of the pipeline is arranged at the surface vessel. The pipeline is therefore lowered from two connection points on the surface vessel.

When the second end of the pipeline is lowered down to the seabed, the lifting device has to carry the full weight of the pipeline, because the remaining portion of the pipeline is arranged at the seabed and the lifting device is the only connection with the surface vessel.

All through the specification including the claims, the words “lifting device”, “yoke”, “hang off clamp” “inboard connecting part”, “second connecting part”, “lifting arms”, “arm locks”, “lock pins”, “guide post”, “guide funnel”, “landing structure”, “pipeline”, “inboard hub”, “outboard hub”, are to be interpreted in the broadest sense of the respective terms and include all similar items in the field known by other terms, as may be clear to persons skilled in the art.

Restriction/limitation, if any, referred to in the specification, is solely by way of example and for understanding the present invention.

### SUMMARY OF THE INVENTION

The invention relates to a lifting device for lowering a pipeline end from a water surface to a seabed, alternatively later retrieval of the same from the seabed to the water surface, said pipeline end being provided with an outboard connecting part designed for mating and connection with an inboard connecting part on the seabed. The invention is distinctive in that the lifting device comprises a hang off clamp adapted for connection with the outboard connecting part,

at least one lifting arm pivotably connected to the hang off clamp at a respective first end of said at least one lifting arm and;

a yoke, said yoke being adapted to be releasable connected to the at least one lifting arm at a respective second end of said lifting arm, said at least one lifting arm having a locking arrangement adapted for securing the at least one lifting arm to the hang off clamp in a non-rotational resting position.

The invention provides a lifting device where the yoke could be retrieved from the seabed or lowered towards the seabed. The yoke could easily be disconnected from the lifting arms and be reused, while the remaining part are attached to the outboard connecting part. There is also no need for the inboard connecting part to be arranged at the seabed before the lifting device is lowering the outboard connection part to the seabed.

In a preferred embodiment of the lifting device according to invention the lifting device comprises two lifting arms arranged one on each side of the hang off clamp. This provides a uniform lifting of the outboard connecting part and the pipeline.

In yet another preferred embodiment of the lifting device according to the invention the hang off clamp comprises a bottom frame and brackets, said hang off clamp being adapted for receiving the outboard connecting part.

In another preferred embodiment of the invention the at least one arm lock is engaging a column in the hang off clamp to secure the lifting arm in the non-rotational position between a vertical connection position where the lifting arms are attached to the yoke and a resting position where the lifting arms are disconnected from the yoke and are adapted to rest on an inboard connecting part 10 connected to the outboard connecting part. This provides easy disconnection of the yoke from the lifting arms and bottom frame.

In another embodiment of the lifting device according to the invention the yoke has at least one locking mechanism for locking the yoke to the at least one lifting arm.

In yet another embodiment of the lifting device according to the invention the yoke has at least one guiding funnel arranged beneath the at least one locking mechanism. The at least one funnel provides easy connection between the yoke and the at least one lifting frame.

In another embodiment of the lifting device according to the invention the yoke have two guiding funnel and two locking mechanism, arranged in pair. This provides a more stable or even lifting of the arrangement.

In another embodiment of the lifting device according to the invention, the arm locks and locking mechanism are actuated by an ROV.

In yet another lifting device according to the invention, the lifting arms are adapted to rest on the inboard connecting part in a resting position.

In yet another embodiment of the lifting device according to the invention the at least one locking mechanism comprises;

a bore adapted to receive a free end of the lifting arms;

a locking pin arranged perpendicular to the bore, said locking pin is adapted to engage with an eye arranged on the lifting arm;

said locking mechanism being is adapted to lock the yoke and the hang off clamp together when lowering or retrieving the outboard connecting part.

In yet another embodiment of the lifting device according to the invention the lifting arms are connected to the brackets through trunnions.

The lifting arms are adapted to rotate in relation to the bottom frame between a substantially vertical position towards a position where the arms are resting on the inboard connecting part.

The invention also relates to a method for lowering a pipeline end from a water surface by using of a lifting device for receiving an outboard connection part designed for mating and connecting with an inboard connecting part arranged on the seabed, said lifting device comprising a hang off clamp with at least one lifting arm rotatably connected to the hang off clamp and a yoke releasably connected to the at least one lifting arm, said method comprising the following steps:
connecting the yoke to the lifting arm,
lowering the lifting device with outboard connecting part and pipeline end towards the seabed,
swiveling the lifting arm to a position suitable for non-rotational connection with the hang off clamp,
connecting the lifting arm to the hang off clamp,
releasing the yoke from the at least one lifting arm,
retrieval of the yoke to the water surface.

The method for lowering a pipeline end from a water surface further rela, wherein after the inboard connecting part and the outboard connecting part are connected, the non-rotational connection between the at least one lifting arm and the hang off clamp is released, said at least one lifting arm is further lowered down to a resting position on the inboard connection part.

The invention also relates to a method for retrieval of a pipeline end from a seabed by use of a lifting device for receiving an outboard connection part designed for mating and connecting with an inboard connecting part arranged on the seabed, said lifting device comprising a hang off clamp with at least one lifting arm rotatably connected to the hang off clamp, and a yoke releasably connected to the at least one lifting arm, said method comprising the following steps:
swiveling of the at least one lifting arm to a position suitable for non-rotational connection with the hang off clamp, lowering the yoke towards the at least one lifting arm,
connecting the yoke to the lifting arm,
releasing the non-rotational connection between the at least one lifting arm and the hang off clamp,
retrieval of the lifting device with the outboard connecting part and the pipeline end to the water surface.

### BRIEF DESCRIPTION OF THE DRAWINGS

Having described the main features of the invention above, a more detailed and non-limiting description of an exemplary embodiment will be given in the following with reference to the drawings.

FIG. 1 shows in perspective view an elevated view of the outboard connecting part of a connector device together with a lifting device according to the invention, viewed from the side.

FIG. 2 shows in a perspective view the lifting device according to the invention attached to the outboard connecting part, viewed from the side.

FIG. 3 shows a cross section of the lifting device and the outboard connecting device according to the invention along a line A-A shown in FIG. 2.

FIG. 4-10 shows the sequences of lowering the lifting device with outboard connecting part and the pipeline end towards the landing structure to be connected to the inboard connecting part. The figures also show the disconnection of the yoke from the hang off clamp.

### DETAILED DESCRIPTION OF THE INVENTION

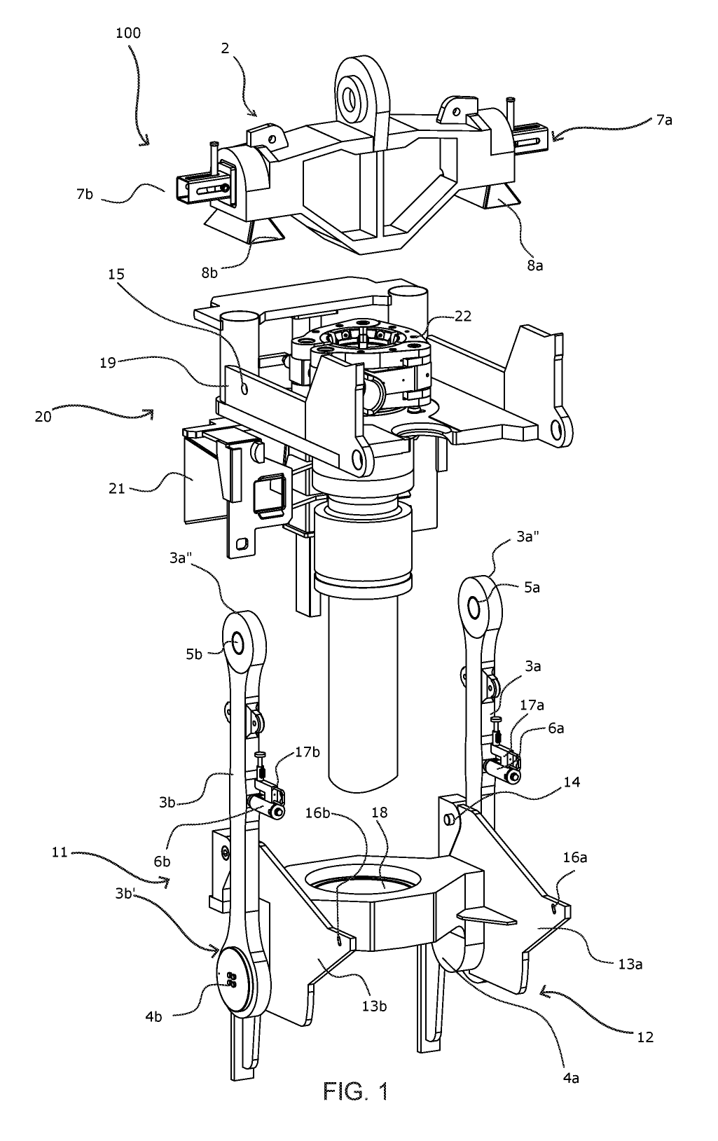

With reference to the FIGS. 1-3, an embodiment of a lifting device 100 according to the invention will now be described. FIG. 1 shows an outboard connecting part 20 for connecting a pipeline to, for instance, another pipeline at the seabed. The connection could also be between a pipeline that is lowered to the seabed and a subsea arrangements (not shown) arranged on the seabed.

The FIGS. 1-3 shows the outboard connecting part 20 as it appears without being connected to a flexible pipeline end (not shown).

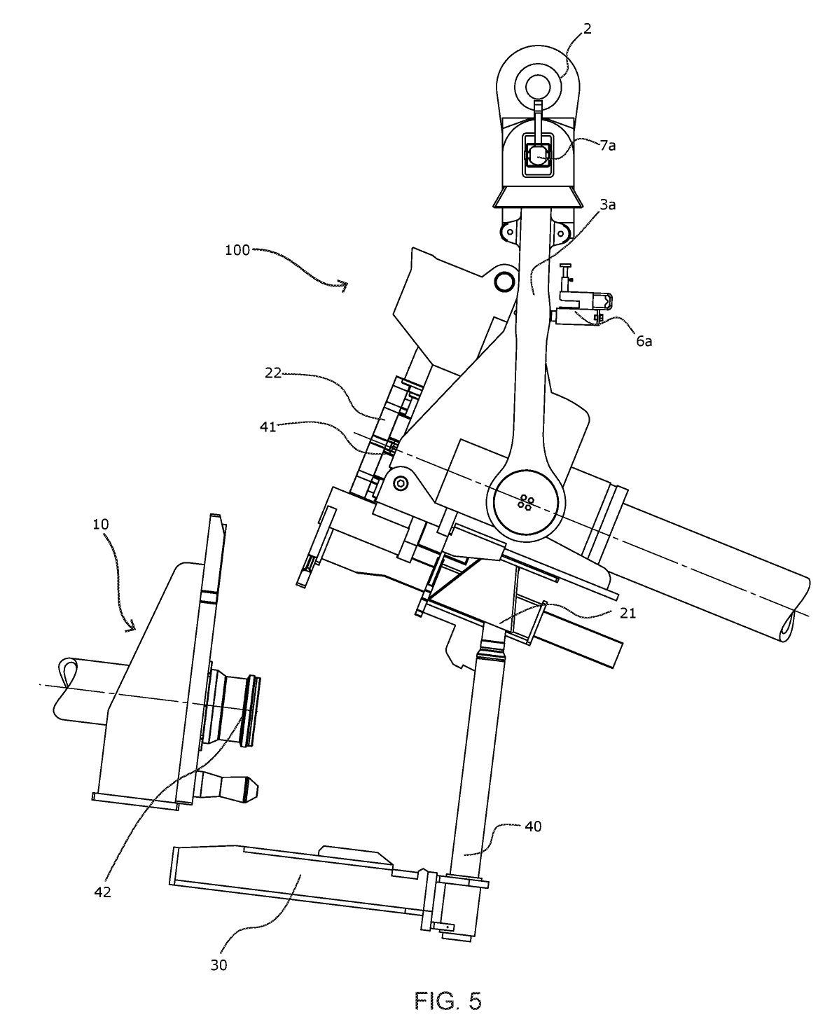

The outboard connecting part 20 is to be guided towards an inboard connecting part 10 and a landing structure 30 to be able to make the connection between the inboard and outboard connecting parts 10 and 20. The outboard connecting part 20′ and the landing structure 30 are shown in FIG. 5-10.

It is also possible to lower the pipeline end with the outboard connecting part 20 on the landing structure 30 before the inboard connection part 10 are deployed on the seabed.

The lifting device 100 is suitable for different designs of the outboard connecting part 10, an example of an outboard connecting part described in Norwegian application NO20150285, filed simultaneously by the same applicant and inventor. The title of this application is “Double guide funnel flexible connection system.” This outboard connection device is advantageous when lowering a pipeline end on the landing structure without immediately connecting the pipeline end to the inboard connecting part.

In the FIGS. 1-4, only the outboard connecting part 20 is shown. The outboard connecting part 20 is adapted to be connected to a hang off clamp 11.

The hang off clamp 11 comprises a bottom frame 12. The outboard connecting part 20 is adapted to rest inside the bottom frame 12 of the hang off clamp 11. The hang off clamp 11 is dimensioned so that the outboard connecting part 20 could be connected to the hang off clamp 11. The outboard connecting part 20 could also be released from the hang off clamp 11. Brackets 13a, 13b are arranged at both sides of the bottom frame 12. The brackets 13a, 13b having each a protrusion 14 arranged at the inside of the brackets 13a, 13b so that the protrusions are 14 facing each other.

The protrusions 14 on the hang off clamp 11 are adapted to engage with corresponding holes 15 arranged at each sides of the outboard connecting part 20 and provides a connection between the outboard connecting part 20 and the hang off clamp 11.

The hang off clamp 11 further comprising two lifting arms 3a, 3b attached to the outside of the brackets 13a, 13b. A first end 3a′ 3b′ of the lifting arms 3a, 3b are connected to the respective outside of the brackets 13a, 13b through trunnions 4a, 4b. The lifting arms 3a, 3b are adapted to rotate around the trunnions 4a, 4b.

The lifting arms have each an opposite free second end 3a″, 3b″ of the lifting arms 3a, 3b. There are arranged an eye 5a, 5b on each of the lifting arms 3a, 3b at or near the free end 3″, 3b″ of the lifting arms 3a, 3b. Between the first end 3a′ 3b′ and the second end 3a″, 3b″of the lifting arms 3a, 3b there are arranged arm locks 6a, 6b. The arm locks 6a, 6b are arranged in a position on the lifting arms 3a, 3b so that it corresponds with a column 16a, 16b in each of the brackets 13a, 13b when the lifting arms 3a, 3b are lowered towards the brackets 13a, 13b The position of the arm locks 6a, 6b at the lifting arms 3a, 3b could have any positions suitable within the objective of the invention to make the connection between the lifting arms 3a, 3b and the brackets 13a, 13b so that the lifting arms are prevented from further rotation.

The arm locks 6a, 6b have each an L-shaped part 17a, 17b that could be rotated outwardly and engage with the column 16a, 16b of the bracket 13a, 13b.

In the center of the hang off clamp 11, there is an opening 18, which has a diameter greater than the pipeline so that the pipeline is allowed to be connected to the outboard connecting part 20 through the opening 18.

The FIG. 1-3 also illustrates a yoke 2, which is releasable connected to the hang off clamp 11 through the lifting arms 3a, 3b. In the FIGS. 1-3, the yoke 2 is shown in a released position from the hang off clamp 11.

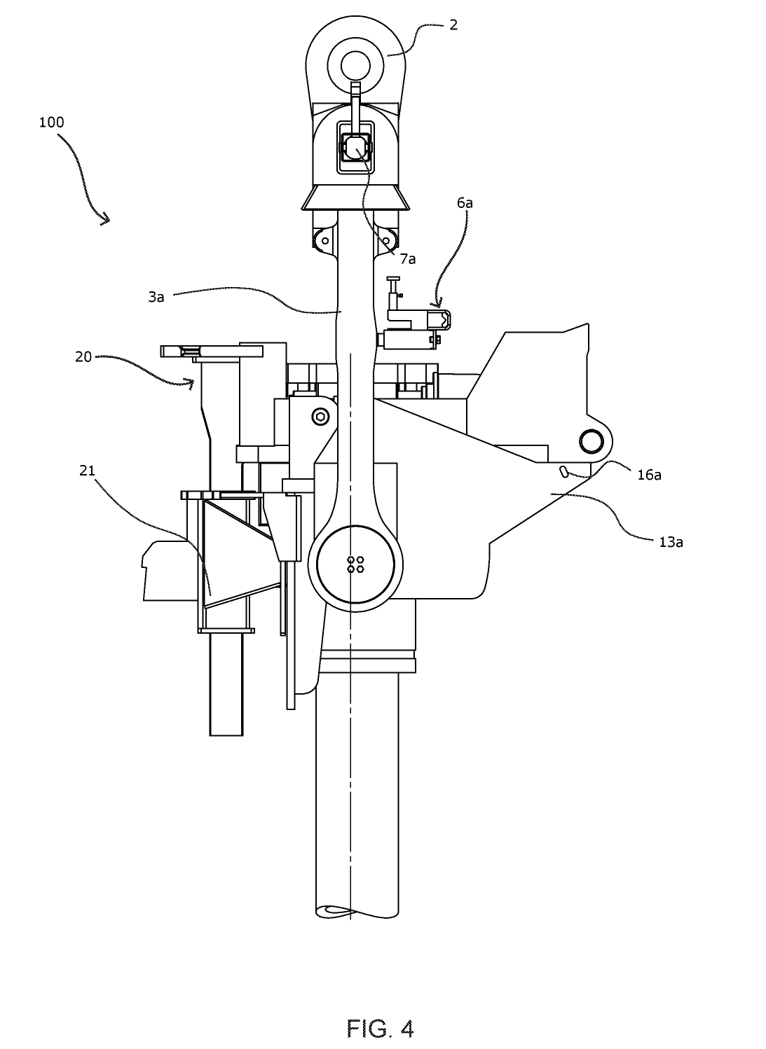

In FIG. 4, the yoke is connected to the hang off clamp in 11 in a connected position. The yoke 2 can be disconnected from the lifting arms 3a, 3b and be brought up to the surface for reuse, while the hang off clamp 11 is remained at the seabed together with the outboard connecting part 20.

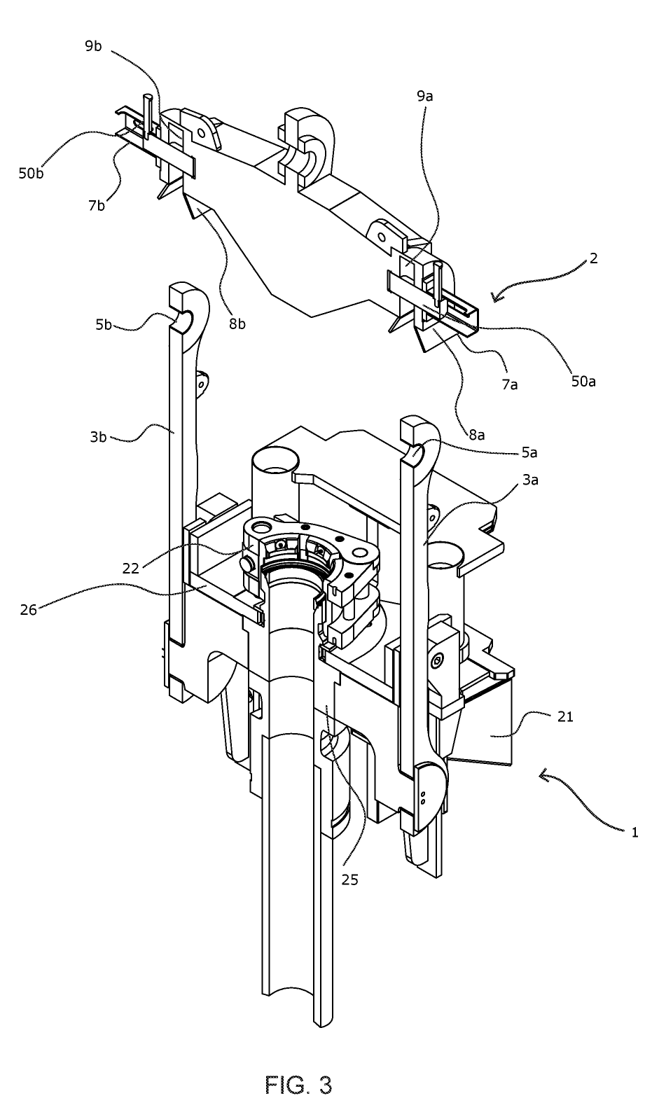

The yoke 2 has locking mechanisms 7a, 7b arranged at each side of the yoke 2. The locking mechanism 7a, 7b are similar on both sides of the yoke 2 and are shown in detail in FIG. 3. The locking mechanism 7a, 7b comprises a yoke, funnel 8a, 8b arranged beneath a vertically aligned bore 9a, 9b which is adapted to receive the second end 3a″, 3b″ of each of the lifting arms 3a, 3b. A locking pin 50a, 50b is arranged perpendicular to the bore 9a, 9b and is slidable in relation to the bore 9a, 9b. The locking pin 50a, 50b is adapted to be pulled out of the bore 9a, 9b in an unlocked position.

Each of the lifting arms 3a, 3b is adapted to be arranged within the bore 9a, 9b of the locking mechanism 7a, 7b and the eye 5a, 5b is then corresponding with the position of the locking pin 50a, 50b. The locking pin 50a, 50b could then be pushed through the eye 5a, 5b to hold the lifting arm 3a, 3b in a secured position within the locking mechanism 7a, 7b, this is referred to as locked position between the yoke 2 and hang off clamp 11. The yoke funnels 8a, 8b are positioned beneath the bores 9a, 9b in order to guide the lifting arms 3a, 3b so that they engage more easily with the bores 9a, 9b.

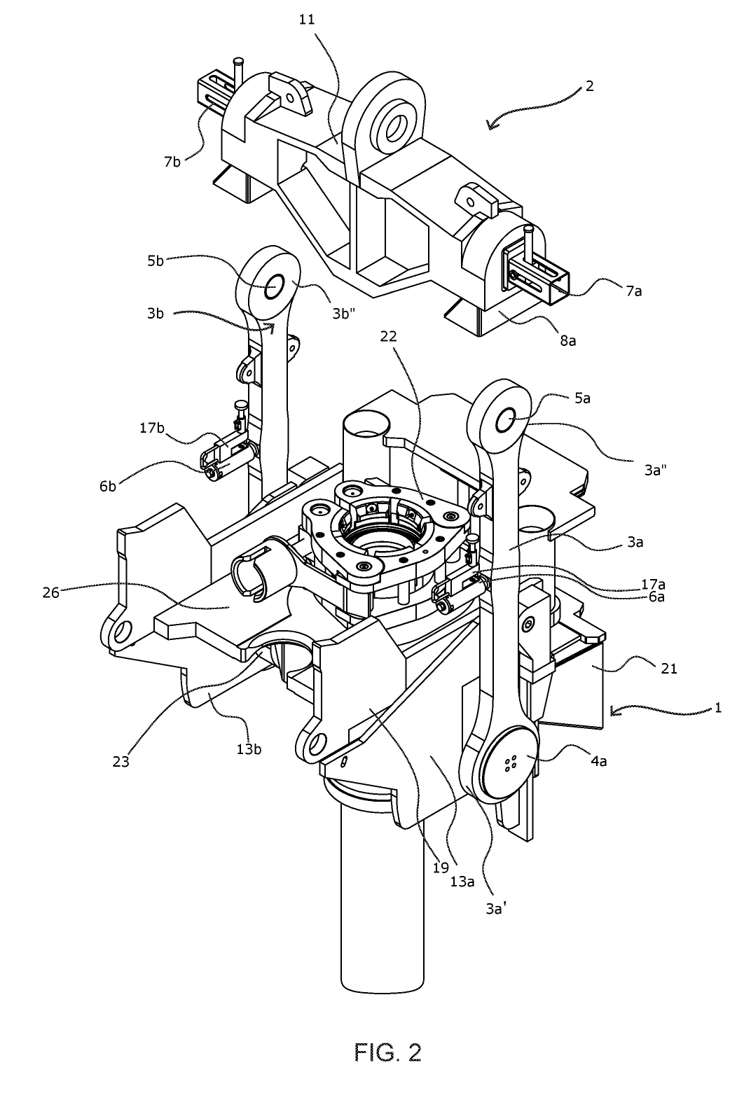

The outboard connecting part 20 comprises an outboard reaction plate 26 (shown in FIG. 2) with a circular opening in the middle of the plate. An outboard hub 25 (shown in FIG. 3) fits in the opening of the reaction plate 26. The outboard hub 25 is adapted to be connected to a pipeline end (not shown) that shall be lowered to the seabed. In the opposite end of the outboard hub 25, there is arranged a clamp connector 22 for connecting the outboard hub 25 to an inboard hub 42 arranged on the inboard connecting part 10.

There is also arranged at least one guide funnel 21 on the outboard connecting part 20. In FIGS. 1-3 there are shown an embodiment with two guide funnels 21 arranged on the outboard connecting part 20.

It is to be noted that the outboard connecting part 20′ has different orientations in the Figures. In FIG. 1-4, the funnels 21 are arranged at one of the sides of the outboard connecting part 20.

When the outboard connecting part 20 is lowered down to the seabed the funnels 21 will mate with at least one guidepost 40 arranged on a landing structure 3 arranged on the seabed, the outboard connecting part 20′ together with the bottom frame 12 and the brackets 13a, 13b are rotated 90° so that the guide funnels 21 are oriented downwards. The at least one guide funnel 21 is then adapted to mate with the at least one guideposts 40. This is shown in FIG. 5.

FIGS. 4 to 10 shows sequences of the lowering of the pipeline end to the seabed with the lifting device 100 according to the invention.

In the figures, the inboard connecting part is already installed at the seabed before lowering the outboard connecting part 20. This is not a requirement. The inboard connecting part 10 could be installed after the lowering of the outboard connecting part 20. The mating operation takes place between the outboard connecting part 20 and the landing structure 30 with the at least one guidepost 40 as assisting means. The at least one guidepost 40 is arranged perpendicular to the landing structure 30

FIG. 4 shows that position where the outboard connecting part 20 is lowered from the sea surface, for example from a surface vessel (not shown). The outboard connecting part 20 is oriented with the guide funnels 21 arranged at one of the sides of the outboard connecting part 20, as described above. The yoke 2 is connected via the lifting arms 3a, 3b by the lock pins 7a, 7b to the hang off clamp 11. The outboard connecting arrangement 20 and the hang off clamp 11 are hanging from the lifting arms 3a, 3b beneath the yoke 2. The lifting arms 3a, 3b are arranged in a vertical line at each side of the outboard connecting part 20. This position is referred to as a connecting position of the lifting arms 3a, 3b.

In FIG. 5 the at least one funnel 21 of the outboard connecting part 20 is downwardly aligned with the at least one guidepost 40. The Figure shows the position when the at least one funnel 21 initially mate with the at least one guidepost 40 arranged on the landing structure 30. The yoke 2 is in this position still connected to the lifting arms 3a, 3b.

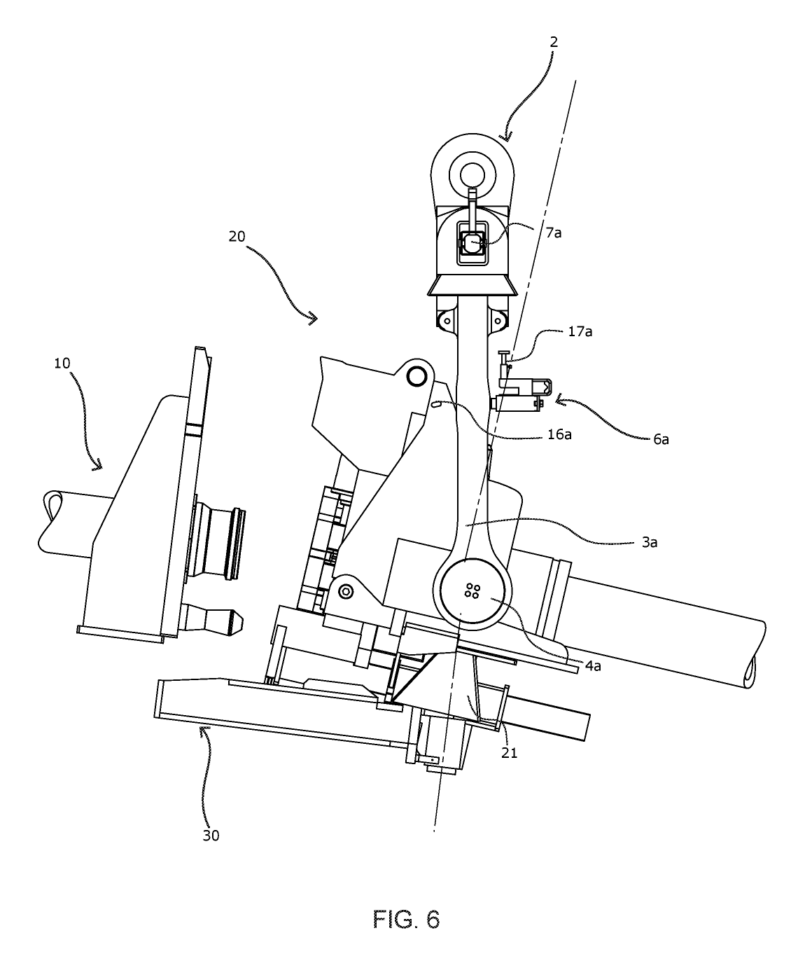

In FIG. 6 the at least one funnel 21 is engaging with the at least one guidepost 40 (shown in FIG. 5) and the outboard connecting part 20 is resting on the landing structure 30.

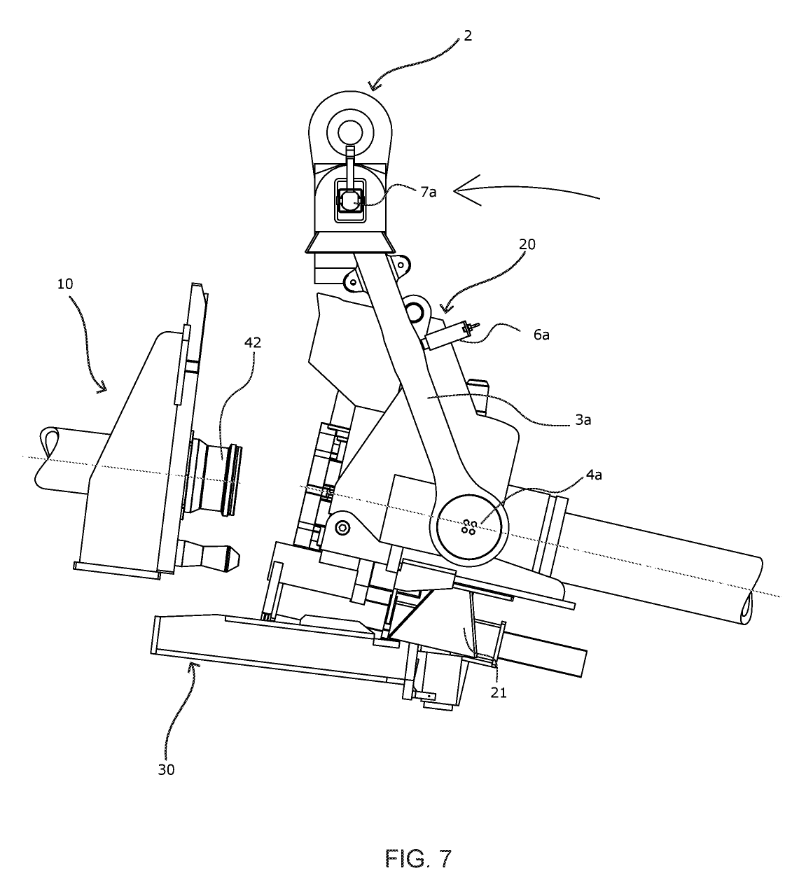

The yoke 2 is further lowered down towards the seabed so that the lifting arms 3a, 3b are rotated around the trunnions 4a, 4b, from a substantially vertical position to an non-rotational position, where the free end of the lifting arms 3a″, 3b″ are brought to a position closer to the landing structure 30. The position of the lifting arms are approximately within a range of 0-45° from a vertical line through the trunnions 4a, 4b. This non-rotational position is shown in FIG. 7.

The arm locks 6a, 6b are in this position adapted to be connected to the brackets 13a, 13b. The L-shaped part 17a, 17b is rotated approximately 90° towards the respective brackets 13a, 13b. The L-shaped part 17a, 17b is then entering the column 16a, 16b and the arms 3a, 3b are locked to the hang off clamp 11. The connection is preferably performed by an ROV.

When the lifting arms 6a, 6b are connected to the brackets 13a, 13b through the arm locks 6a, 6b, the lifting arms 3a, 3b are fixed in this position until the arm locks 6a, 6b are released from the brackets 13a, 13b. The release of the lifting arms 3a, 3b is preferably performed by an ROV (not shown). The locking mechanism 6a, 6b described, is an embodiment of the locking mechanism to lock the lifting arms in a position. Other arrangements of the locking mechanism 6a, 6b is possible and are embodiments of the invention.

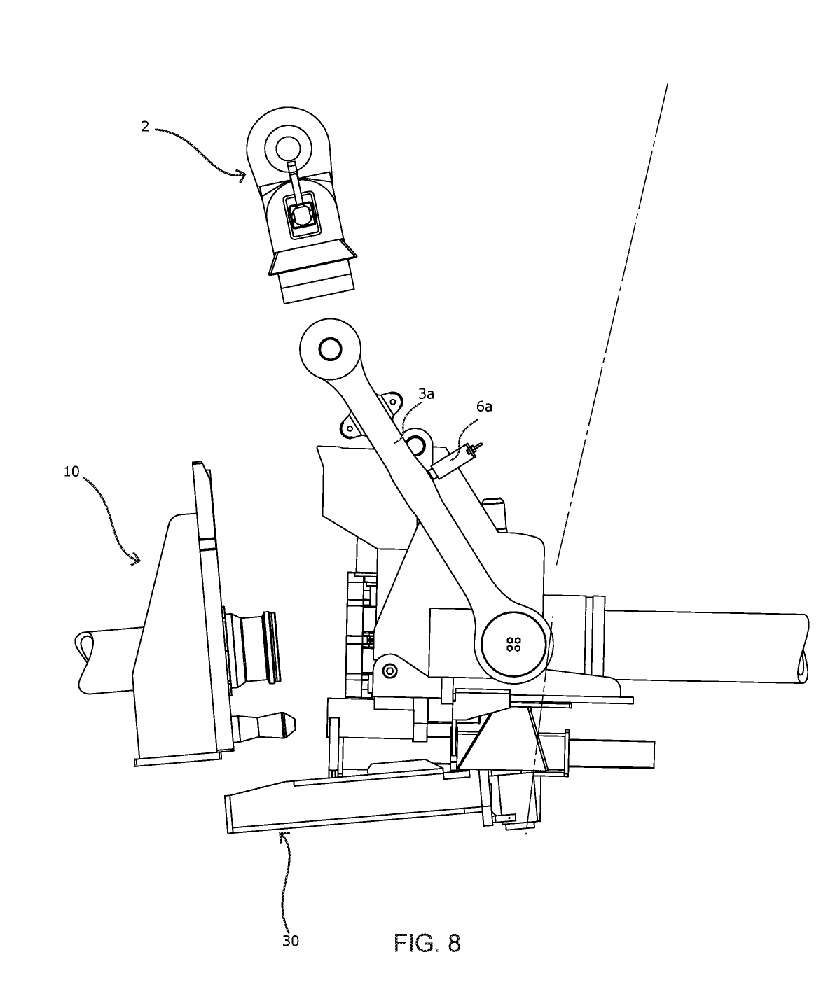

FIG. 8 shows a position when the yoke 2 is released from the lifting arms 3a, 3b. The lock pins 7a, 7b are released from the eye 5a, 5b of the lifting arms 3a, 3b as described earlier. This is preferably performed by an ROV but other releasing arrangement of the lock pins 7a, 7b are also embodiments of the invention.

FIG. 9 shows the mating of the outboard connecting part 20 and inboard connecting part 10 in a conventional manner with a stroke tool 44 installed between the first connecting part 10 and the outboard connecting part 20. One end of the tool 44 is arranged in a slot 23 in the reaction plate 26 of the outboard connecting part 20 as shown in FIG. 3. The other end is arranged in a similar slot (not shown) on an inboard reaction plate 19 of the inboard connecting part 10. The stroke tool 44 is adapted to move the outboard connecting part 20 towards the inboard connecting part 10, into a position where an inboard hub 42 arranged on the inboard connecting part 10 is abutting the outboard hub 25 on the outboard connecting part 20.

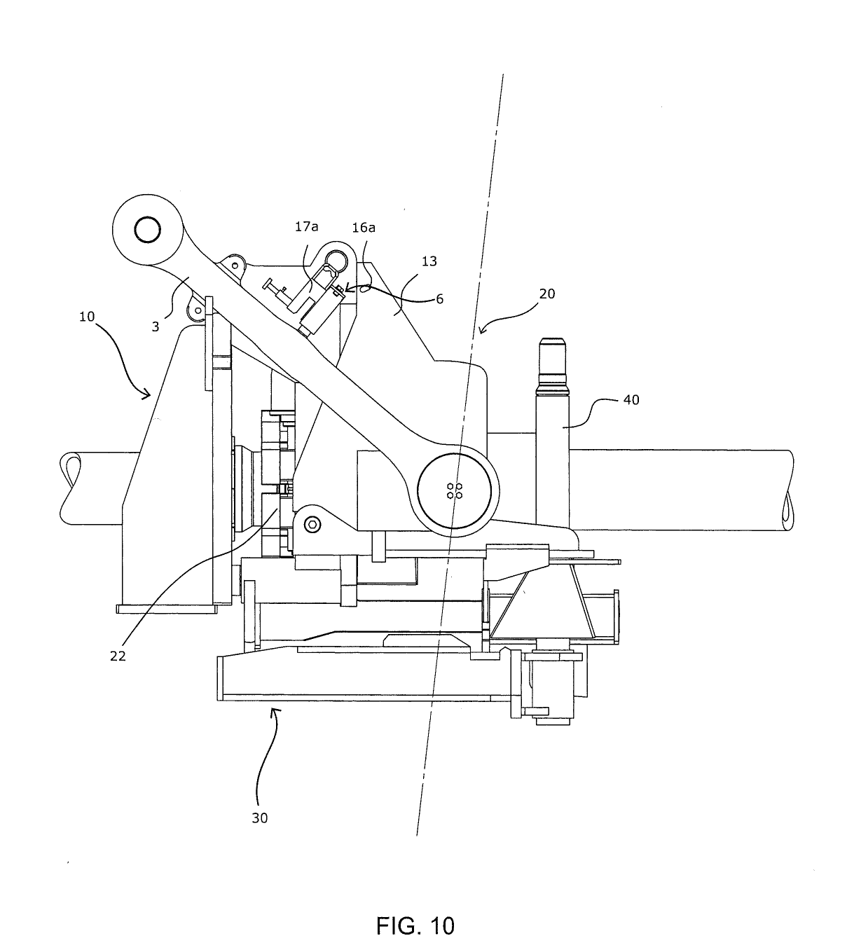

FIG. 10 shows the situation when the inboard hub 42 and the outboard hub 25 are connected to each other through a clamp connector 22. The clamp connector 22 is normally attached to the outboard hub 25 on the outboard connecting part 20 before it is connecting the two parts together. After the connection of the inboard connecting part 10 and the outboard connecting part 20, the arm locks 6a, 6b are released from the brackets 13a, 13b. The L-shaped part of the arm locks 17a, 17b is released from the column 16a, 16b. The lifting arms 3a, 3b are rotated further down towards the inboard connecting part 10 until the lifting arms 3a, 3b rests on the inboard connecting part 20. In this position, the lifting arms (3a, 3b) are in a resting position. The lifting arms (3a, 3b) shown in the figure are not attached to the inboard connecting part 10, but it is an embodiment of the invention to attach the lifting arms to the inboard connecting part in a releasable connection.

The FIGS. 4 to 10 shows sequences of the lowering and mating of the inboard 10 and outboard 20 connecting parts using the lifting device. It is to be understood that the reverse action of the lifting device 100 is also possible.

The lifting arm is moved from the resting position to the non rotational position and locked to the brackets 13a, 13b as described earlier.

The yoke 2 is lowered to a position where it engages with the eyes 5a, 5b of the lifting arms 3a, 3b. The yoke 2 could then be connected to the lifting arms 3a, 3b through the lock pins 7a, 7b, and the outboard connecting part 20 with the attached pipeline could then be lifted to the sea level by the lifting device 100.

The present invention has been described with reference to a preferred embodiment and some drawings for the sake of understanding only, and it should be clear to persons skilled in the art that the present invention includes all legitimate modifications within the ambit of what has been described hereinbefore and claimed in the appended claims.

1. A lifting device for lowering a pipeline end from a water surface to a seabed, alternatively later retrieval of the same from the seabed to the water surface, said pipeline end being provided with an outboard connecting part designed for mating and connection with an inboard connecting part on the seabed, the lifting device comprising:
a hang off clamp adapted for connection with the outboard connecting part, at least one lifting arm pivotably connected to the hang off clamp at a respective first end of said at least one lifting arm and;
a yoke, said yoke being adapted to be releasable connected to the at least one lifting arm at a respective second end of said lifting arm, said at least one lifting arm comprising a locking arrangement adapted for securing the at least one lifting arm to the hang off clamp in a non-rotational position.

2. A lifting device according to claim 1, wherein the lifting device comprises two lifting arms, arranged one on each side of the hang off clamp.

3. A lifting device according to claim 1, wherein the hang off clamp comprises a bottom frame and brackets, said hang off clamp being adapted for receiving the outboard connecting part.

4. A lifting device according to claim 1, wherein the at least one arm lock is engaging a column in the hang off clamp to secure the lifting arm in the non-rotational position.

5. A lifting device according to claim 1, wherein the yoke comprises at least one locking mechanism for locking the yoke to the at least one lifting arm.

6. A lifting device according to claim 5, wherein the yoke comprises at least one guiding funnel arranged beneath the at least one locking mechanism.

7. A lifting device according to claim 6, wherein the yoke comprise two guiding funnel and two locking mechanism, arranged in pair.

8. A lifting device according to claim 6, wherein the arm locks and the locking mechanism are actuated by an ROV.

9. A lifting device according to claim 1, wherein the lifting arms are adapted to rest on a inboard connecting part in a resting position.

10. A lifting device according to claim 6, wherein the at least one locking mechanism comprises;
a bore adapted to receive a free end of the lifting arms;
a locking pin arranged perpendicular to the bore, said locking pin being adapted to engage with an eye arranged on the lifting arm; said locking mechanism being adapted to lock the yoke and the hang off clamp together when lowering or retrieving the outboard connecting part.

11. A lifting device according to claim 1, wherein the lifting arms are connected to the brackets through trunnions.

12. A method for lowering a pipeline end from a water surface by using of a lifting device for receiving an outboard connection part designed for mating and connecting with an inboard connecting part arranged on the seabed, said lifting device comprising a hang off clamp with at least one lifting arm rotatably connected to the hang off clamp and a yoke releasably connected to the at least one lifting arm, said method comprising the following steps:
connecting the yoke to the lifting arm,
lowering the lifting device with outboard connecting part and pipeline end towards the seabed,
swiveling the lifting arm to a position suitable for non-rotational connection with the hang off clamp,
connecting the lifting arm to the hang off clamp,
releasing the yoke from the at least one lifting arm, and
retrieval of the yoke to the water surface.

13. The method for lowering a pipeline end from a water surface according to claim 12, wherein after the inboard connecting part and the outboard connecting part are connected, the non-rotational connection between the at least one lifting arm and the hang off clamp is released, said at least one lifting arm is further lowered down to a resting position on the inboard connection part.

14. A method for retrieval of a pipeline end from a seabed by use of a lifting device for receiving an outboard connection part designed for mating and connecting with an inboard connecting part arranged on the seabed, said lifting device comprising a hang off clamp with at least one lifting arm rotatably connected to the hang off clamp, and a yoke releasably connected to the at least one lifting arm, said method comprising:
swiveling of the at least one lifting arm to a position suitable for non-rotational connection with the hang off clamp, lowering the yoke towards the at least one lifting arm,
connecting the yoke to the at least one lifting arm,
releasing the non-rotational connection between the at least one lifting arm and the hang off clamp, and
retrieval of the lifting device with the outboard connecting part and the pipeline end to the water surface.
